(19) United States
(12) Patent Application Publication
(10) Pub. No.: US 2025/0099849 A1
(43) Pub. Date: Mar. 27, 2025

(54) ADAPTIVE ENCODING BASED ON INDIVIDUAL GAMER SENSITIVITY TO VISUAL ARTIFACTS

(71) Applicant: Sony Interactive Entertainment Inc., Tokyo (JP)

(72) Inventors: Deepali Arya, San Mateo, CA (US); Eric Chen, San Mateo, CA (US)

(21) Appl. No.: 18/475,127

(22) Filed: Sep. 26, 2023

(51) Int. Cl. A63F 13/355; A63F 13/67

(52) U.S. Cl. CPC A63F 13/355; A63F 13/67; A63F 2300/535; A63F 2300/538

(57) ABSTRACT

Techniques are described for an encoder or decoder to adaptively change coding based on a specific user's sensitivity to flickering, or flashing, or blockiness, or other visual artifacts. Alternatively, video may be pre-processed based on the user's sensitivity to suppress artifacts prior to encoding and/or post-processed to suppress artifacts after decoding.

### FIELD

The present application relates to technically inventive, non-routine solutions that are necessarily rooted in computer technology and that produce concrete technical improvements, and more specifically to adaptive encoding based on individual gamer sensitivity to visual artifacts.

### BACKGROUND

Computer game play often occurs over a network, in which the game itself may be streamed and multiple gamers who may be remote from each other play the same game. Streaming gaming presents technical challenges related to energy use and network limitations. For example, stringent energy demands may be imposed on network computing that limit the capacity of the network to carry data. Moreover, the sheer volume of data that may sought to be sent over a network can overwhelm network capabilities particularly in the so-called “last mile”. Multiple problems arise from these limitations, including decreased bandwidth and increased latency.

### SUMMARY

As understood herein, data transmission load may be reduced under some conditions and specifically for present purposes by reducing or eliminating certain corrective actions to encode and/or decode video for certain people who may not negatively experience flickering, flashing, blockiness, pixelation, blurring, or other visual artifacts as much as other people.

Accordingly, an apparatus includes at least one processor assembly configured to receive information pertaining to a first user's sensitivity to at least one visual artifact, and receive information pertaining to a second user's sensitivity to at least one visual artifact. The processor assembly is configured to encode and/or decode pre-process and/or post-process at least one video for presentation on a first display according to the information pertaining to the first user's sensitivity to the visual artifact. Furthermore, the processor assembly is configured to encode and/or decode pre-process and/or post-process the video for presentation on a second display according to the information pertaining to the second user's sensitivity to the visual artifact.

The video may include at least one computer game.

The visual artifact may include one or more of flickering, flashing, and blockiness.

In another aspect, an apparatus includes at least one computer medium that is not a transitory signal and that in turn includes instructions executable by at least one processor assembly to identify a first user's sensitivity to at least one visual artifact in video, and encode and/or decode at least one video for presentation on a first display associated with the first user according to the first user's sensitivity to the visual artifact.

In another aspect, a method includes receiving indication of a perceptual sensitivity to video and pre-processing the video prior to encoding and/or post-processing the video after decoding according to the indication. The method includes presenting the video on at least one display.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder-decoder system;

FIG. 3 illustrates an example specific system consistent with present principles;

FIG. 4 illustrates example logic in example flow chart format for training a ML model to execute present techniques;

FIG. 5 illustrates example logic in example flow chart format for using a ML model to execute present techniques;

FIGS. 6 and 7 illustrate example encoder-side logic in example flow chart format for executing present techniques for first and second users with different sensitivities;

FIGS. 8 and 9 illustrate example decoder-side logic in example flow chart format for executing present techniques for first and second users with different sensitivities;

FIGS. 10 and 11 illustrate example encoder-side logic in example flow chart format for executing present pre-processing suppression techniques; and

FIG. 12 illustrates example decoder-side logic in example flow chart format for executing present post-processing suppression techniques.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

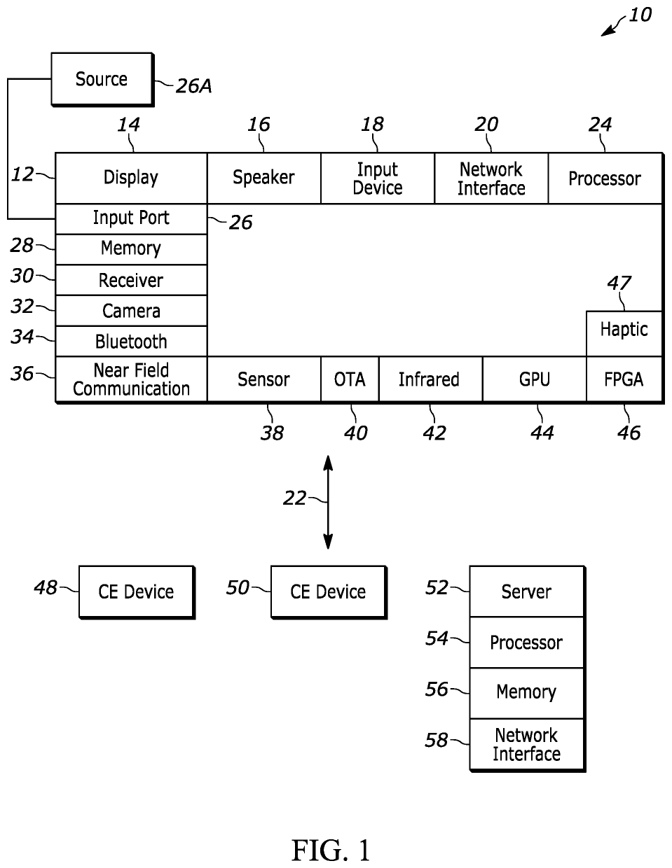

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

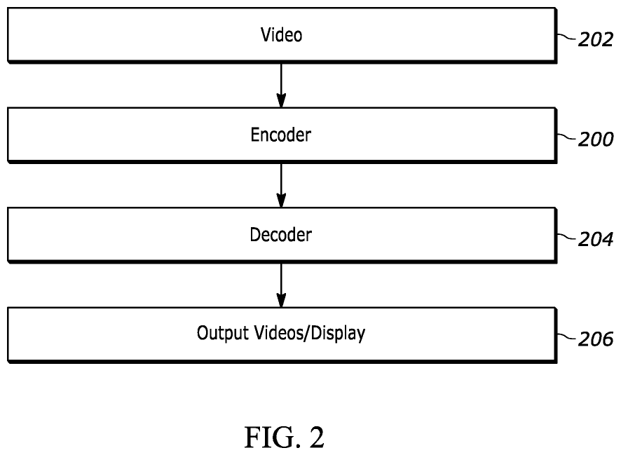

FIG. 2 illustrates a system that includes a video encoder 200 for encoding/compressing videos 202. A video decoder 204 can receive the encoded videos and decode/decompress them into output videos 206.

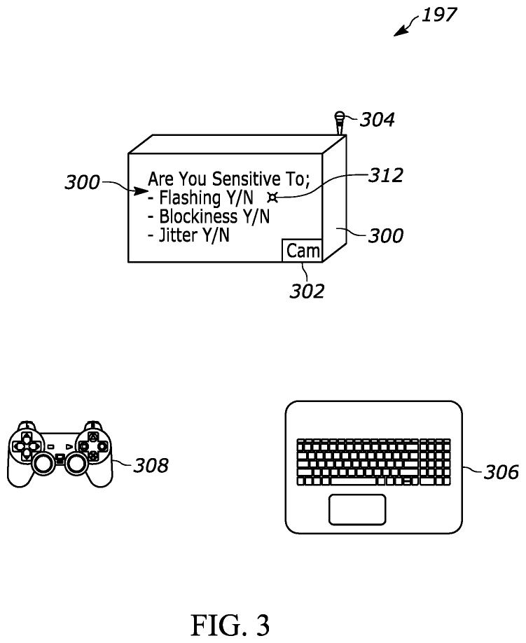

FIG. 3 illustrates an example system of an end user gamer which includes one or more displays 300 such as touchscreen displays, one or more cameras 302, one or more microphones 304, one or more key entry devices 306 such as keyboard or keypads, and one or more computer game controllers 308 such as a Sony PlayStation controller. A user interface (UI) (310) may be presented, e.g., on the display, or on speakers, or otherwise to query the user whether the user is sensitive to one or more visual artifacts in video such as flashing, blockiness, jitter, etc. The user may input indication of any such sensitivity through any of the input devices shown, including verbally through the microphone, signing as detected by the camera, manipulating the controller or keyed entry device, or selecting from the touchscreen. Note that the UI may show the user examples of artifacts as indicated at 312, in addition to simply querying the user about specific artifacts.

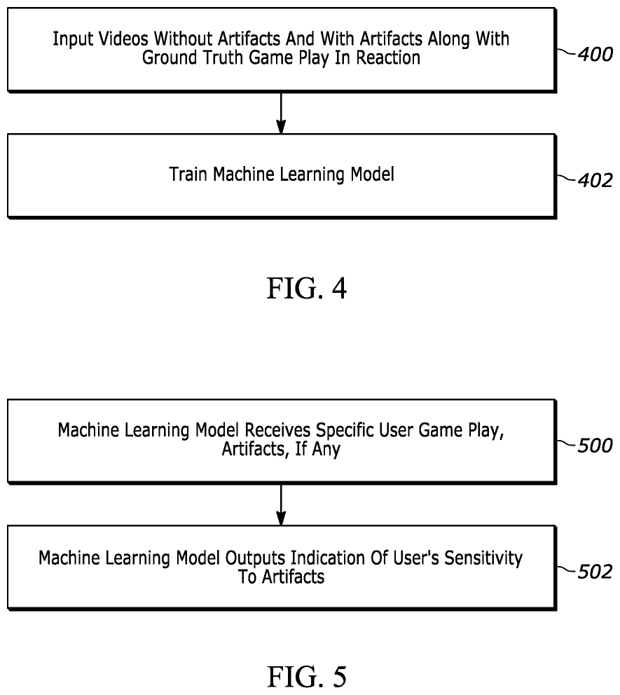

FIG. 4 illustrates an alternate technique for identifying user sensitivity to video artifacts using machine learning (ML). A training set of data is input at state 400 to a ML model to train the model at state 402. The training set may include, for example, gameplay videos without artifacts and gameplay videos with artifacts along with ground truth indicating gamer reaction to the artifacts, so the model learns what types of gamer behavior indicate sensitivity (or not) to artifacts.

This is shown in FIG. 5. Commencing at state 500, the ML model trained as described receives the gameplay of a specific user and identifies artifacts, if any, in the video. Moving to state 502, the model outputs an indication of the sensitivity of the user to the artifacts, e.g., from “none” to “significant sensitivity”, if desired in quantitative terms.

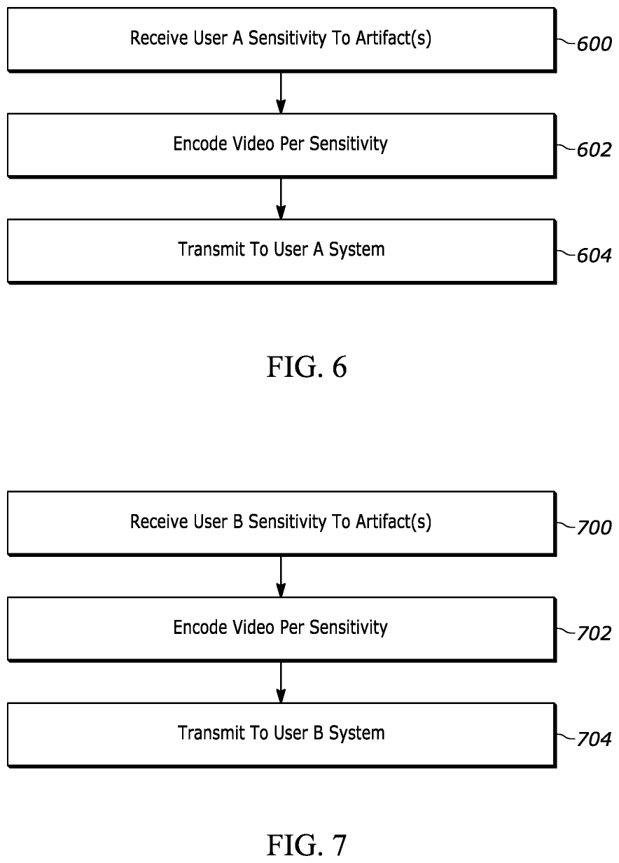

Refer now to FIG. 6. Commencing at state 602, the indication of the sensitivity of a specific first user to one or more visual artifacts in video is identified. Proceeding to state 604, video intended to be streamed to the user is encoded according to the indication of sensitivity for the first user. For example, if the user is not sensitive to one or more artifacts, the video may be encoded at a lower bit rate than if the user is sensitive to one or more artifacts. Assume the video is encoded in a first manner (e.g., at a first bit rate and/or frame rate and/or resolution) for the first user. The encoded video is transmitted over a network to the first user at state 604.

In contrast, FIG. 7 illustrates encoding for a second, specific user. Commencing at state 700, the indication of the sensitivity of the second user to one or more visual artifacts in video is identified. Proceeding to state 702, video intended to be streamed to the second user is encoded according to the indication of sensitivity for the second user. Assume the video is encoded in a second manner (e.g., at a second bit rate and/or frame rate and/or resolution) for the second user. The encoded video is transmitted over a network to the second user at state 704. Thus, depending on their sensitivity to visual artifacts in video, video may be encoded differently for different users.

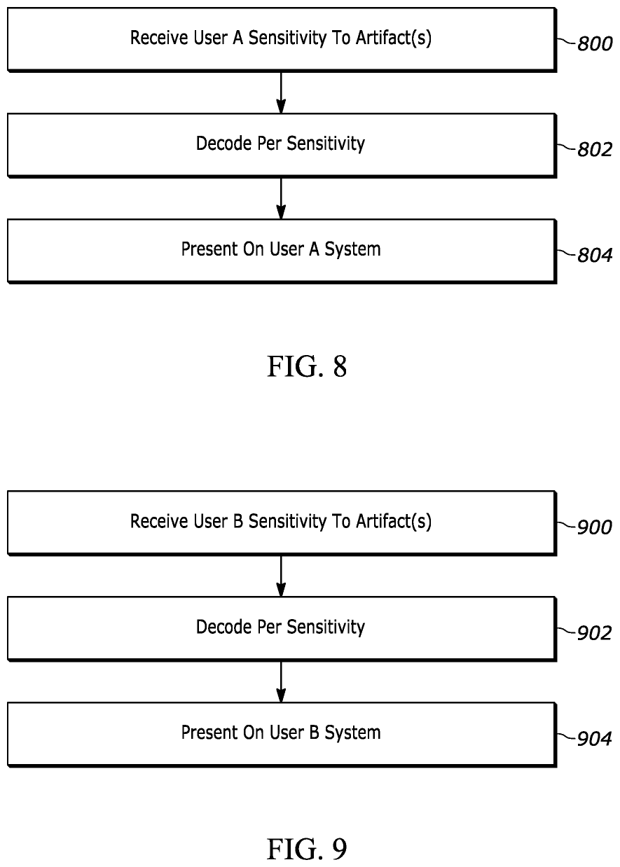

In addition or alternatively, video may be decoded differently for different users depending on their sensitivity to visual artifacts in video. FIGS. 8 and 9 illustrate. Commencing at state 800 in FIG. 8, the indication of the sensitivity of a specific first user to one or more visual artifacts in video is identified. Proceeding to state 802, video streamed to the user is decoded according to the indication of sensitivity for the first user. For example, if the user is not sensitive to one or more artifacts, the video may be decoded at a lower bit rate than if the user is sensitive to one or more artifacts. Assume the video is decoded in a first manner (e.g., at a first bit rate and/or frame rate and/or resolution) for the first user. The decoded video is presented on at least one display associated with the first user at state 804.

In contrast, FIG. 9 illustrates decoding for a second, specific user. Commencing at state 900, the indication of the sensitivity of the second user to one or more visual artifacts in video is identified. Proceeding to state 902, video streamed to the second user is decoded according to the indication of sensitivity for the second user. Assume the video is decoded in a second manner (e.g., at a second bit rate and/or frame rate and/or resolution) for the second user. The decoded video is presented on at least one display associated with the second user at state 904. Thus, depending on their sensitivity to visual artifacts in video, video may be decoded differently for different users.

While FIGS. 6-9 contemplate streaming video such as computer games over a network, they may be applied in non-streaming environments such as games played by a local game engine executing in a computer game console.

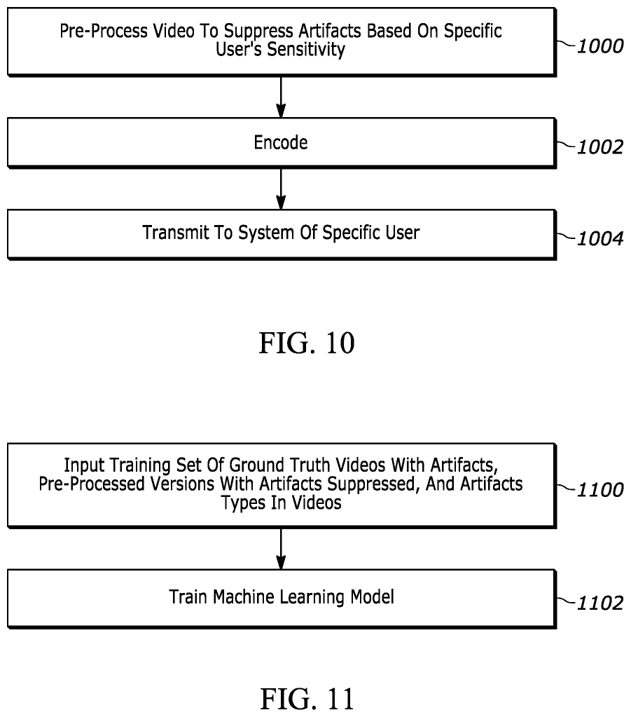

Note that the encoding and decoding techniques may be applied in the case of multiple artifacts and in particular may be particularly suited to blockiness (blocks in the video). Refer now to FIG. 10 for a pre-processing technique to suppress artifacts in content such as bright flashes and flickering lights. The techniques herein also may be used to map original colors in video to different colors more suitable for a colorblind user whose color perception characteristics are known. The techniques herein also may be used to alter speed of motion of objects and/or the relevant virtual camera that “filmed” the video as appropriate to alleviate motion sickness in a user susceptible to motion sickness.

Commencing at state 1000 in FIG. 10, video intended to be provided to a user via streaming or from a computer console is pre-processed to suppress artifacts in the content (as opposed to artifacts caused by encoding) such as any of the relevant artifacts discussed herein according to the nature of the sensitivity of a specific user. The video is then encoded at state 1002 and transmitted or played on a system associated with the specific user at state 1004.

The suppression at pre-processing state 1000 may be performed by a human expert or by a ML model. FIG. 11 illustrates how such a model may be trained.

Commencing at state 1100, a training set of data is sent to the ML model to train it at state 1102. The training set may include videos with various content-related artifacts in them along with a ground truth indication of what the artifacts are, and pre-processed videos derived from the original videos in which the ground truth artifact has been suppressed.

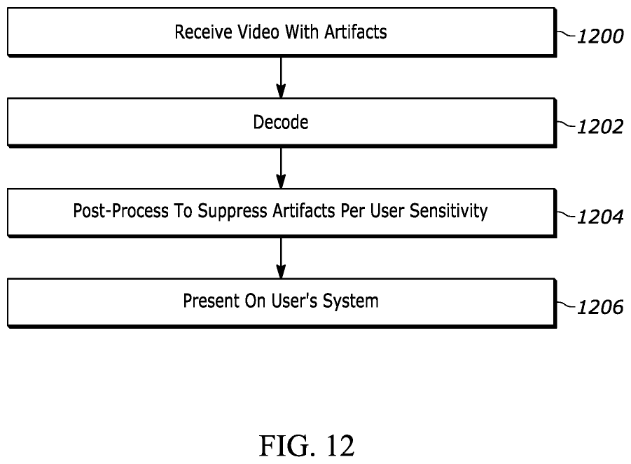

FIG. 12 illustrates that the techniques above may be used in a post-processing step at the receiver after decoding a video with content-related artifacts in it. Commencing at state 1200 in FIG. 12, video with artifacts is received via streaming or from a computer console. Proceeding to state 1202 the video is decoded by the receiver.

Moving to state 1204, the video is post-processed to suppress artifacts in the content (as opposed to artifacts caused by encoding) such as any of the relevant artifacts discussed herein according to the nature of the sensitivity of a specific user. The video is then presented at state 1206 on a display of the user whose sensitivity was used at state 1204 to suppress the artifacts.

The suppression at pre-processing state 1200 may be performed by a human expert or by a ML model trained, e.g., in accordance with FIG. 11.

While particular techniques are herein shown and described in detail, it is to be understood that the subject matter which is encompassed by the present application is limited only by the claims.

What is claimed is:

1. An apparatus comprising:
at least one processor assembly configured to:
receive information pertaining to a first user's sensitivity to at least one visual artifact;
receive information pertaining to a second user's sensitivity to at least one visual artifact;
encode and/or decode and/or pre-process and/or post-process at least one video for presentation on a first display according to the information pertaining to the first user's sensitivity to the visual artifact; and
encode and/or decode and/or pre-process and/or post-process the video for presentation on a second display according to the information pertaining to the second user's sensitivity to the visual artifact.

2. The apparatus of claim 1, wherein the video comprises at least one computer game.

3. The apparatus of claim 1, wherein the processor assembly configured to:
encode the video for presentation on the first display according to the information pertaining to the first user's sensitivity to the visual artifact; and
encode the video for presentation on the second display according to the information pertaining to the second user's sensitivity to the visual artifact.

4. The apparatus of claim 1, wherein the processor assembly configured to:
decode the video for presentation on the first display according to the information pertaining to the first user's sensitivity to the visual artifact; and
decode the video for presentation on the second display according to the information pertaining to the second user's sensitivity to the visual artifact.

5. The apparatus of claim 1, wherein the processor assembly configured to:
pre-process at least one video for presentation on the first display according to the information pertaining to the first user's sensitivity to the visual artifact; and
pre-process the video for presentation on the second display according to the information pertaining to the second user's sensitivity to the visual artifact.

6. The apparatus of claim 1, wherein the processor assembly configured to:
post-process the at least one video for presentation on the first display according to the information pertaining to the first user's sensitivity to the visual artifact; and
post-process the video for presentation on the second display according to the information pertaining to the second user's sensitivity to the visual artifact.

7. The apparatus of claim 1, wherein the visual artifact comprises flickering or flashing.

8. The apparatus of claim 1, wherein the visual artifact comprises blockiness.

9. An apparatus comprising:
at least one computer medium that is not a transitory signal and that comprises instructions executable by at least one processor assembly to:
identify a first user's sensitivity to at least one visual artifact in video; and
encode and/or decode at least one video for presentation on a first display associated with the first user according to the first user's sensitivity to the visual artifact.

10. The apparatus of claim 9, wherein the video comprises at least one computer game.

11. The apparatus of claim 9, wherein the instructions are executable to:
encode the video for presentation on the first display according to the first user's sensitivity to the visual artifact.

12. The apparatus of claim 9, wherein the instructions are executable to:
decode the video for presentation on the first display according to the first user's sensitivity to the visual artifact.

13. The apparatus of claim 9, wherein the visual artifact comprises flickering.

14. The apparatus of claim 9, wherein the visual artifact comprises flashing.

15. The apparatus of claim 9, wherein the visual artifact comprises blockiness.

16. A method comprising:
receiving indication of a perceptual sensitivity to video;
pre-processing the video prior to encoding according to the indication; or
post-processing the video after decoding according to the indication; or
both pre-processing and post-processing the video according to the indication; and
presenting the video on at least one display.

17. The method of claim 16, wherein the display is associated with at least one input device from whence the indication is received.

18. The method of claim 16, comprising:
pre-processing the video prior to encoding according to the indication.

19. The method of claim 16, comprising:
post-processing the video after decoding according to the indication.

20. The method of claim 16, comprising:
both pre-processing and post-processing the video according to the indication.
